(19) United States
(12) Patent Application Publication
(10) Pub. No.: US 2004/0233168 A1
(43) Pub. Date: Nov. 25, 2004

(54) System and methods for interacting with a supplemental hand-held mouse

(75) Inventor: Todd M. Christenson, Vermillion, SD (US)

Correspondence Address: Gateway, Inc., Attention: Scott Charles Richardson, 610 Gateway Drive, MS Y-04, N.Sioux City, SD, 57049, US

(73) Assignee: Gateway, Inc.

(21) Appl. No.: 10/441,740

(22) Filed: May 19, 2003

(51) Int. Cl. G09G 5/08

(52) U.S. Cl. 345/163

(57) ABSTRACT

Systems and methods for providing a wireless supplemental mouse interface for interacting with a wireless supplemental mouse are disclosed. The wireless supplemental mouse operates in addition to a primary mouse. In one aspect, the wireless supplemental mouse interface is physically integrated within a computer system such as a personal computer, server, or workstation. In another aspect, the wireless supplemental mouse interface is not physically integrated with a computer system, but instead is a remote interface that is coupled with a plurality of computer systems via a network. The remote wireless supplemental mouse interface receives signals from one or more wireless supplemental mice and determines which system to send the signals to for further processing.

### FIELD

The present invention relates to computerized systems, and in particular to computerized systems operable to interact with a supplemental hand-held mouse.

### BACKGROUND

The introduction of the computer mouse revolutionized computer user interfaces. The mouse enabled the development of the point-and-click style interface used in practically all personal computers and personal computer software today.

The mouse is typically a single user input device. That is, only one person can be using a mouse at a particular time. This can lead to problems in certain situations. For example, in a classroom setting it may be necessary for an instructor use the mouse to guide a user in the use of a software application. In this case, the instructor and the user must either change places so that the instructor can use the mouse, or the instructor must lean over or kneel near the user. This can place the instructor in an awkward position and make it difficult for the instructor to use the mouse.

Similar problems exist in collaborative computer sessions where more than one user may need to user the computer. For example, two or more users may be working together to develop software, edit documents, or play a game. In each of these situations, there may be contention for use of the mouse.

In view of the problems and issues noted above, there is a need in the art for the present invention.

### SUMMARY

The above-mentioned shortcomings, disadvantages and problems are addressed by the present invention, which will be understood by reading and studying the following specification.

Embodiments of the invention provide a wireless supplemental mouse interface for interacting with a wireless supplemental mouse. The wireless supplemental mouse operates in addition to a primary mouse. In one aspect, the wireless supplemental mouse interface is physically integrated within a computer system such as a personal computer, server, or workstation.

In another aspect, the wireless supplemental mouse interface is not physically integrated with a computer system, but instead is a remote interface that is coupled with a plurality of computer systems via a network. The remote wireless supplemental mouse interface receives signals from one or more wireless supplemental mice and determines which system to send the signals to for further processing.

The present invention describes systems, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIGS. 1A-C are block diagrams of logical components of systems for interacting with a supplemental mouse according to various embodiments of the invention.

FIGS. 2A-B are flowcharts illustrating methods for a computer system to interact with a supplemental mouse.

FIG. 3 is an architectural block diagram of a computer system utilizing the current invention.

FIGS. 4A-B are illustrations of hand-held supplemental mice according to various embodiments of the invention.

### DETAILED DESCRIPTION

In the following description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

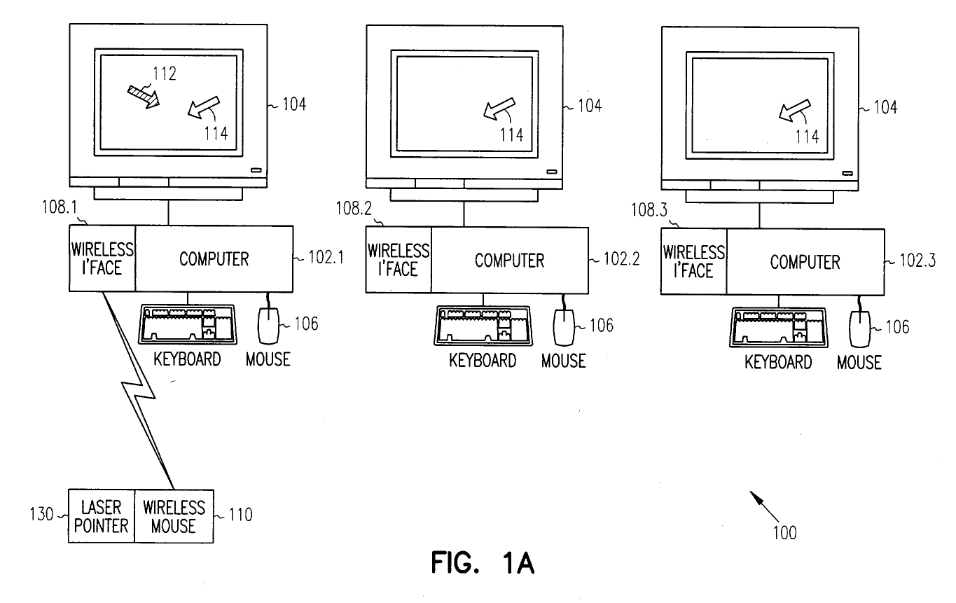

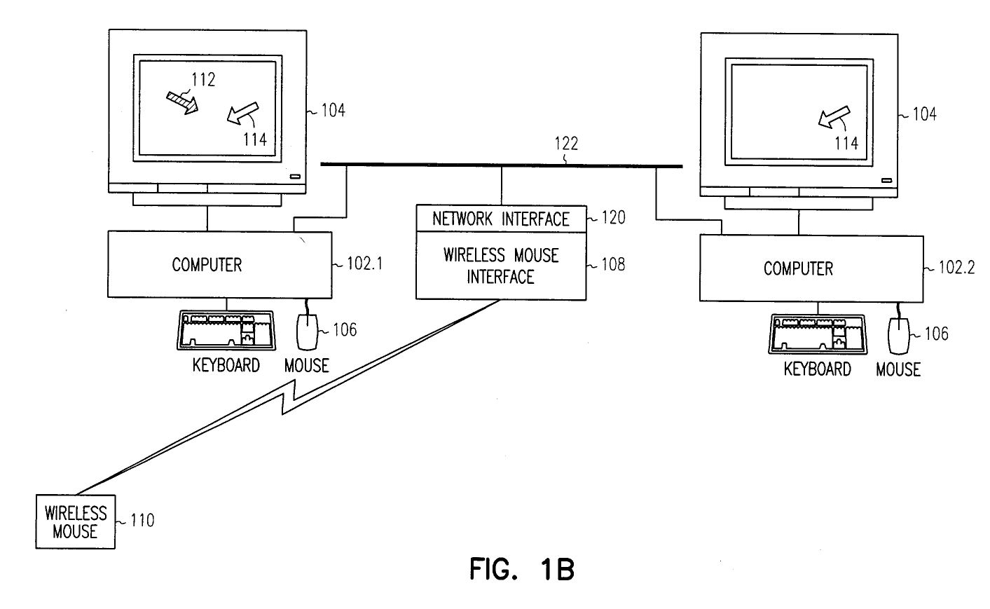

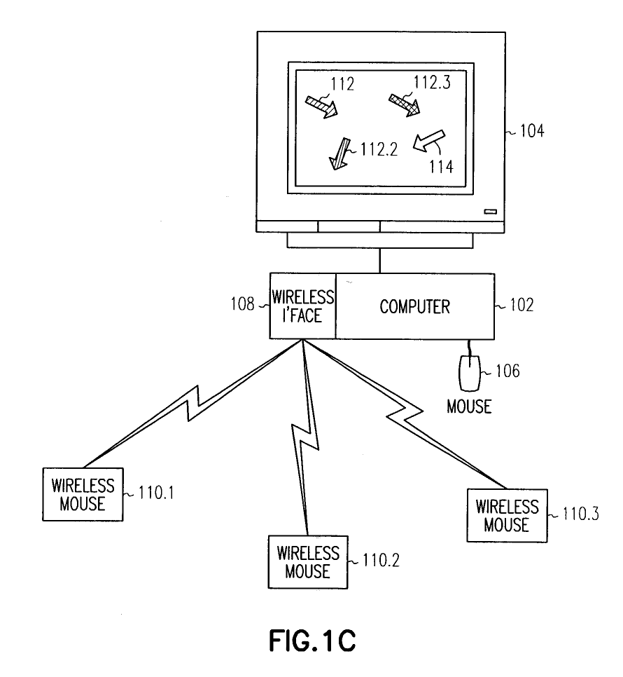

FIG. 1A is a block diagram of an exemplary environment 100 incorporating embodiments of the invention for interacting with a wireless supplemental mouse 110. As shown, the exemplary environment 100 includes computer systems 102. While three computer systems 102.1-102.3 are shown, those of skill in the art will appreciate that the number of computer systems in environment 100 may be arbitrary. The invention is not limited to any particular number of computer systems 102.

Computer system 102 may be any type of computer system that interfaces with a primary mouse 106. For example, computer system 102 may be a personal computer, a server computer, a mainframe computer, or a laptop computer. Primary mouse 106 comprises the mouse typically used by a user of computer system 102. Typically primary mouse 106 interfaces to computer 102 through a mouse interface such as a PS2 port (not shown). For the purposes of the specification, primary mouse refers to a mouse that is typically present when the system boots up, and is the mouse the system uses in the absence of the supplemental mouse of the present invention. Primary mouse 106 typically provides signals to computer system 102, which are used to control the movement of a primary cursor 114 on a monitor 104 associated with the computer system 102.

Computer system 102 may also include a wireless supplemental mouse interface 108. Wireless supplemental mouse interface 108 is operable to receive signals from a corresponding wireless supplemental mouse 110. In some embodiments, the wireless interface is an infrared interface. In alternative embodiments, the wireless interface is a radio frequency interface. In further alternative embodiments, the wireless interface is a Bluetooth interface. The present invention is not limited to any particular style or type of wireless interface.

In some embodiments, wireless supplemental mouse interface detects that a wireless supplemental mouse is in proximity to the computer system 102. Proximity may be determined by a number of means, including determining the distance from the wireless supplemental mouse interface 108 to the wireless supplemental mouse. If that distance is less than a predetermined distance, the wireless supplemental mouse is considered in proximity. The predetermined distance may be a default value, or a configurable value.

In some embodiments, wireless supplemental mouse interface 108.1 detects the motion of wireless supplemental mouse 110. This motion may be used to move a cursor on monitor 104. In some embodiments of the invention, the cursor may be primary cursor 114 that is also controlled by primary mouse 106. In alternative embodiments, a secondary cursor 112 is displayed on monitor 104 in addition to primary cursor 114. The secondary cursor 112 may be indicated by a different color, fill style, or different shape than primary cursor 114. In some embodiments, secondary cursor 112 may be a “display only” cursor. In other words, the secondary cursor may be used to direct a user's attention to particular areas of the monitor 104. In alternative embodiments of the invention, secondary cursor 112 may be used to select the same user interface elements such as buttons, menus, icons etc. as primary cursor 114.

In some embodiments of the invention, wireless supplemental mouse 110 includes a laser pointing device 130. The laser pointer device 130 may be used to present the cursor 112 or 114 in a clearer detail. In some embodiments, the laser pointing device 130 provides a means for the secondary cursor 112 to be easily seen by the original user, and not confused with the cursor controlled by the primary mouse 106. In addition, laser pointing device 130 may be used to direct the eye to a point of reference rapidly and allow a more accurate pointing device. Further, the laser pointing device 130 on wireless supplemental mouse 110 may also point to different systems or to a whiteboard, chalkboard or map displayed in a room with out interaction with individual computer systems 102.

FIG. 1B is a block diagram of an exemplary environment according to an alternative embodiment of the invention for interacting with a wireless supplemental mouse 110. The system as shown in FIG. 1B is similar to that shown in FIG. 1A, with the exception that a single wireless supplemental mouse interface 108 is able to provide service to multiple computer systems 102. The wireless supplemental mouse interface and computer systems 102 are connected via a network 122. In some embodiments, network 122 is a LAN (Local Area Network). However, the invention is not limited to any particular type of network, and in alternative embodiments network 122 may be a corporate network, an intranet, or the Internet. Additionally, network 122 may comprise wired segments, wireless segments, or a combination of the two.

In some embodiments, as signals are generated by wireless mouse 110, they are received by wireless mouse interface 108. Wireless mouse interface 108 determines which system the signals should be sent to, and routes the signals through network interface 120 to network 122.

The following example will illustrate the operation of system 100 in FIGS. 1A and 1B. Assume that environment 100 comprises a teaching environment where multiple students each have a computer system 102. As the students execute software on their computer system 102, they may need the help of an instructor. The instructor may use a wireless supplemental mouse 110 to interact with the student's computer system 102.1 in order to cause either the primary cursor 114 or secondary cursor 112 to move to (and potentially select) the correct user interface element according the lesson. The user may duplicate the instructor's mouse movements with their own primary mouse in order to reinforce the correct action. In some embodiments, the instructor's actions are only performed on the student's computer system 102.1 and not other student's computer systems 102.2 and 102.3 because the wireless supplemental mouse interface detects the proximity of the wireless supplemental mouse and only reacts if the wireless supplemental mouse is proximate to the system.

FIG. 1C is a block diagram of an exemplary environment according to an alternative embodiment of the invention for interacting with a plurality of wireless supplemental mice 110. In the exemplary environment illustrated, three wireless supplemental mice 110.1-110.3 are illustrated. Those of skill in the art will appreciate that any number of supplemental mice may be used and that the invention is not limited to any particular number of wireless supplemental mice. In some embodiments of the invention, each wireless supplemental mouse operates at a different frequency, thereby allowing wireless supplemental mouse interface 108 to determine which mouse is supplying a particular signal.

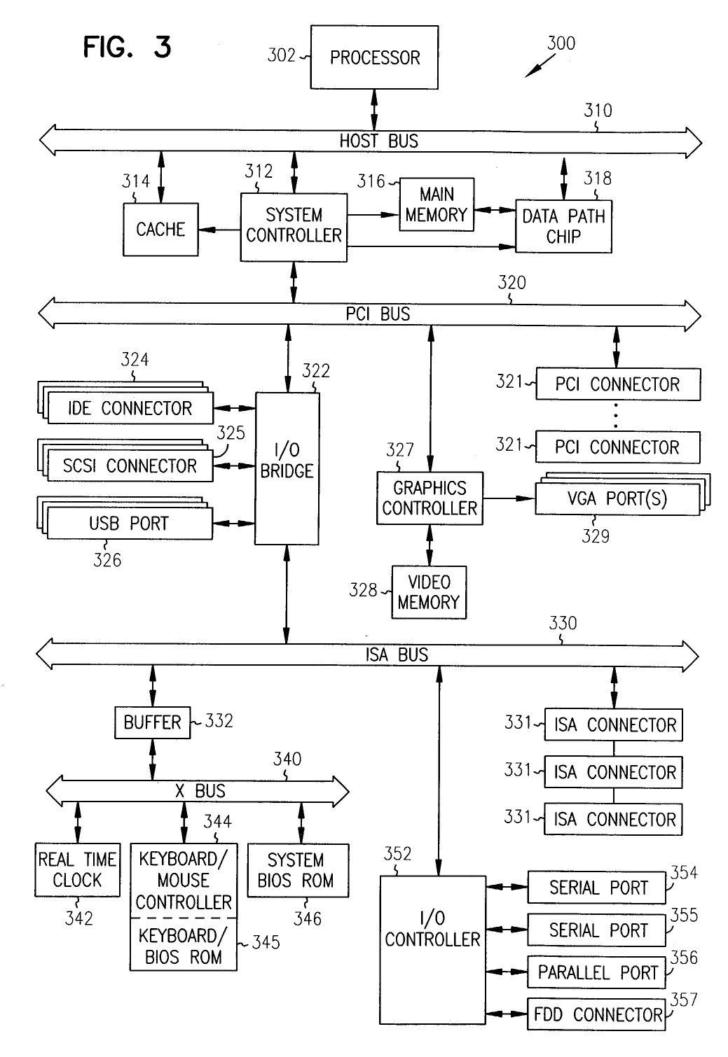

In some embodiments of the invention, each wireless supplemental mouse controls a separate secondary cursor 112. In the example shown in FIG. 3, wireless supplemental mice 110.1-110.3 control secondary cursors 112.1-112.3 respectively. In some embodiments, secondary cursors 112.1-112.3 may be differentiated based on color, fill pattern, shape, size or combination of the aforementioned characteristics.

FIG. 1C illustrates an environment in which multiple wireless supplemental mice communicate with a wireless supplemental mouse interface 108 that is integrated with a computer system 102. It should be noted that in alternative embodiments of the invention, multiple wireless supplemental mice may communicate with a wireless supplemental mouse interface 108 that is not integrated, i.e. that is remote from computer system 102 such as the wireless supplemental mouse interface 108 illustrated in FIG. 1B.

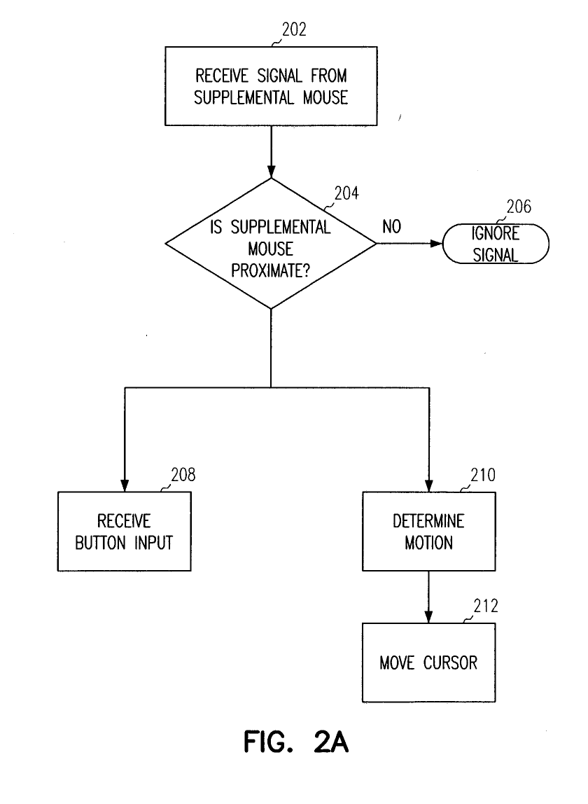

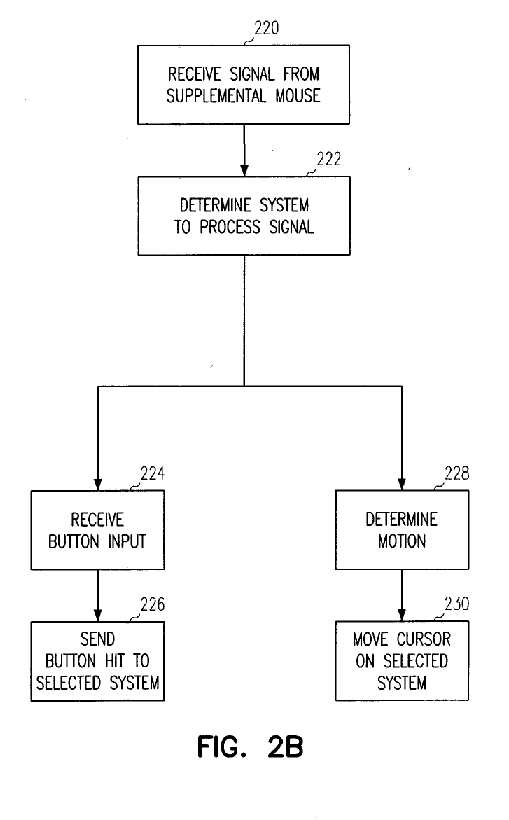

In the previous section, system level overviews of the operation of exemplary embodiments of the invention were described. In this section, the particular methods of the invention performed by an operating environment executing an exemplary embodiment are described by reference to a series of flowcharts shown in FIGS. 2A-2B. The methods to be performed by the operating environment constitute computer programs made up of computer-executable instructions. Describing the methods by reference to a flowchart enables one skilled in the art to develop such programs including such instructions to carry out the methods on suitable computers (the processor of the computer executing the instructions from computer-readable media). The methods illustrated in FIGS. 2A-2B are inclusive of the acts performed by an operating environment executing an exemplary embodiment of the invention.

FIG. 2A is a flowchart illustrating a method for a computer system to interface with one or more wireless supplemental mice. The method begins when a system executing the method receives a signal from a wireless supplemental mouse (block 202). The signal may be an infrared signal, or the signal may be a radio frequency signal.

Next, in some embodiments, the system determines if the wireless supplemental mouse is proximate to the receiving system (block 204). Proximity may be determined in a number of ways. In some embodiments, the signal strength of the signal received from a wireless supplemental mouse may be used to determine proximity. In these embodiments, if the signal strength exceeds a predetermined value, then the wireless supplemental mouse may be considered proximate to the receiving system.

In alternative embodiments of the invention, position of the wireless supplemental mouse determines if the mouse is proximate to the system. In some embodiments, multiples receivers in wireless supplemental mouse interface 108 use the difference in the time of signal arrival to determine the position of a wireless supplemental mouse. Methods of determining the position of a signal-emitting device such as a wireless supplemental mouse are known in the art.

If the wireless supplemental mouse is not determined to be proximate, the system ignores signals from that mouse (block 206). Otherwise, the system proceeds to process signals from the wireless supplemental mouse. Different types of signals may be processed independently of one another as illustrated in the two branches shown in FIG. 2A. Signals indicating a button hit on a wireless supplemental mouse may be received (block 208).

In addition, the system may determine that the mouse has moved (block 210). In some embodiments of the invention, mouse movement is determined by the wireless supplemental interface detecting a change in the position of the mouse using the same techniques used to determine if the mouse is proximate. In alternative embodiments, internal mechanisms in the wireless supplemental mouse may send an indication of the mouse movement in the input signal. Methods for a wireless supplemental mouse to internally detect motion are known in the art.

Motion of the wireless supplemental mouse may then be used to determine the motion of a cursor on the system (block 212). In some embodiments of the invention, the cursor in the primary cursor for the system. In alternative embodiments, the cursor is a secondary cursor for the system.

FIG. 2B is a flowchart illustrating a method for multiple computer systems to interface with one or more wireless supplemental mice according to embodiments of the invention. The method begins when a wireless supplemental mouse interface receives a signal from a wireless supplemental mouse (block 220). In some embodiments, the wireless supplemental mouse interface is a remote interface connected to a plurality of systems via a network as shown in FIG. 1B. However, in alternative embodiments, the wireless supplemental mouse interface may be integrated with a computer system 102.1 as shown in FIG. 1A.

Next, a system executing the method determines which system should process the signal (block 222). Typically the determination is made by selecting the system that is most proximate to the wireless supplemental mouse. Methods of determining proximity have been described above with respect to FIG. 2A. In alternative embodiments of the invention, a user interface may be provided that allows a user to select the system to process the mouse input.

Different types of signals may be processed independently of one another as illustrated in the two branches shown in FIG. 2B. Signals indicating a button hit on a wireless supplemental mouse may be received (block 224). The wireless supplemental mouse interface then routes the button-hit indication to the selected system (block 226).

In addition, the system may determine that the mouse has moved (block 228). Mechanisms for detecting wireless supplemental mouse motion have been described above. The motion data is the routed to the selected system. Motion of the wireless supplemental mouse may be used by the selected system to determine the motion of a cursor on the selected system (block 230). In some embodiments of the invention, the cursor in the primary cursor for the system. In alternative embodiments, the cursor is a secondary cursor for the system.

FIG. 3 is a block diagram of a computer system 300 in which embodiments of the invention may be implemented. In some embodiments, computer system 300 comprises a processor 302, a system controller 312, a cache 314, and a data-path chip 318, each coupled to a host bus 310. Processor 302 is a microprocessor such as a 486-type chip, a Pentium®, Pentium® II, Pentium® III, Pentium® 4, or other suitable microprocessor. Cache 314 provides high-speed local-memory data (in one embodiment, for example, 512 kB of data) for processor 302, and is controlled by system controller 312, which loads cache 314 with data that is expected to be used soon after the data is placed in cache 314 (i.e., in the near future). Main memory 316 is coupled between system controller 312 and data-path chip 318, and in one embodiment, provides random-access memory of between 16 MB and 256 MB or more of data. In one embodiment, main memory 316 is provided on SIMMs (Single In-line Memory Modules), while in another embodiment, main memory 316 is provided on DIMMs (Dual In-line Memory Modules), each of which plugs into suitable sockets provided on a motherboard holding many of the other components shown in FIG. 3. Main memory 316 includes standard DRAM (Dynamic Random-Access Memory), EDO (Extended Data Out) DRAM, SDRAM (Synchronous DRAM), or other suitable memory technology. System controller 312 controls PCI (Peripheral Component Interconnect) bus 320, a local bus for system 300 that provides a high-speed data path between processor 302 and various peripheral devices, such as graphics devices, storage drives, network cabling, etc. Data-path chip 318 is also controlled by system controller 312 to assist in routing data between main memory 316, host bus 310, and PCI bus 320.

In one embodiment, PCI bus 320 provides a 32-bit-wide data path that runs at 33 MHz. In another embodiment, PCI bus 320 provides a 64-bit-wide data path that runs at 33 MHz. In yet other embodiments, PCI bus 320 provides 32-bit-wide or 64-bit-wide data paths that run at higher speeds. In one embodiment, PCI bus 320 provides connectivity to I/O bridge 322, graphics controller 327, and one or more PCI connectors 321 (i.e., sockets into which a card edge may be inserted), each of which accepts a standard PCI card. In one embodiment, I/O bridge 322 and graphics controller 327 are each integrated on the motherboard along with system controller 312, in order to avoid a board-connector-board signal-crossing interface and thus provide better speed and reliability. In the embodiment shown, graphics controller 327 is coupled to a video memory 328 (that includes memory such as DRAM, EDO DRAM, SDRAM, or VRAM (Video Random-Access Memory)), and drives VGA (Video Graphics Adaptor) port 329. VGA port 329 can connect to industry-standard monitors such as VGA-type, SVGA (Super VGA)-type, XGA-type (eXtended Graphics Adaptor) or SXGA-type (Super XGA) display devices.

In one embodiment, graphics controller 327 provides for sampling video signals in order to provide digital values for pixels. In further embodiments, the video signal is provided via a VGA port 329 to an analog LCD display.

Other input/output (I/O) cards having a PCI interface can be plugged into PCI connectors 321. Network connections providing video input are also represented by PCI connectors 321, and include Ethernet devices and cable modems for coupling to a high speed Ethernet network or cable network which is further coupled to the Internet.

In one embodiment, I/O bridge 322 is a chip that provides connection and control to one or more independent IDE or SCSI connectors 324-325, to a USB (Universal Serial Bus) port 326, and to ISA (Industry Standard Architecture) bus 330. In this embodiment, IDE connector 324 provides connectivity for up to two standard IDE-type devices such as hard disk drives, CDROM (Compact Disk-Read-Only Memory) drives, DVD (Digital Video Disk) drives, videocassette recorders, or TBU (Tape-Backup Unit) devices. In one similar embodiment, two IDE connectors 324 are provided, and each provide the EIDE (Enhanced IDE) architecture. In the embodiment shown, SCSI (Small Computer System Interface) connector 325 provides connectivity for up to seven or fifteen SCSI-type devices (depending on the version of SCSI supported by the embodiment). In one embodiment, I/O bridge 322 provides ISA bus 330 having one or more ISA connectors 331 (in one embodiment, three connectors are provided). In one embodiment, ISA bus 330 is coupled to I/O controller 352, which in turn provides connections to two serial ports 354 and 355, parallel port 356, and FDD (Floppy-Disk Drive) connector 357. At least one serial port is coupled to a modem for connection to a telephone system providing Internet access through an Internet service provider. In one embodiment, ISA bus 330 is connected to buffer 332, which is connected to X bus 340, which provides connections to real-time clock 342, keyboard/mouse controller 344 and keyboard BIOS ROM (Basic Input/Output System Read-Only Memory) 345, and to system BIOS ROM 346.

The integrated system performs several functions identified in the block diagram and flowchart of FIGS. 1A, 1B, 1C, 2A and 2B. Such functions are implemented in software in one embodiment, where the software comprises computer executable instructions stored on computer readable media such as disk drives coupled to connectors 324 or 325, and executed from main memory 316 and cache 314.

The invention can be embodied in a number of forms, for example, in the form of computer readable code, or other instructions, on a computer readable medium. Computer readable medium is any data storage device that can store code, instructions or other data that can be thereafter be read by a computer system or processor. Examples of the computer readable medium include read-only memory, random access memory, CD-ROMs, magnetic storage devices or tape, and optical data storage devices. The computer readable medium can configured within a computer system, communicatively coupled to a computer, or can be distributed over network-coupled computer systems so that the computer readable code is stored and executed in a distributed fashion.

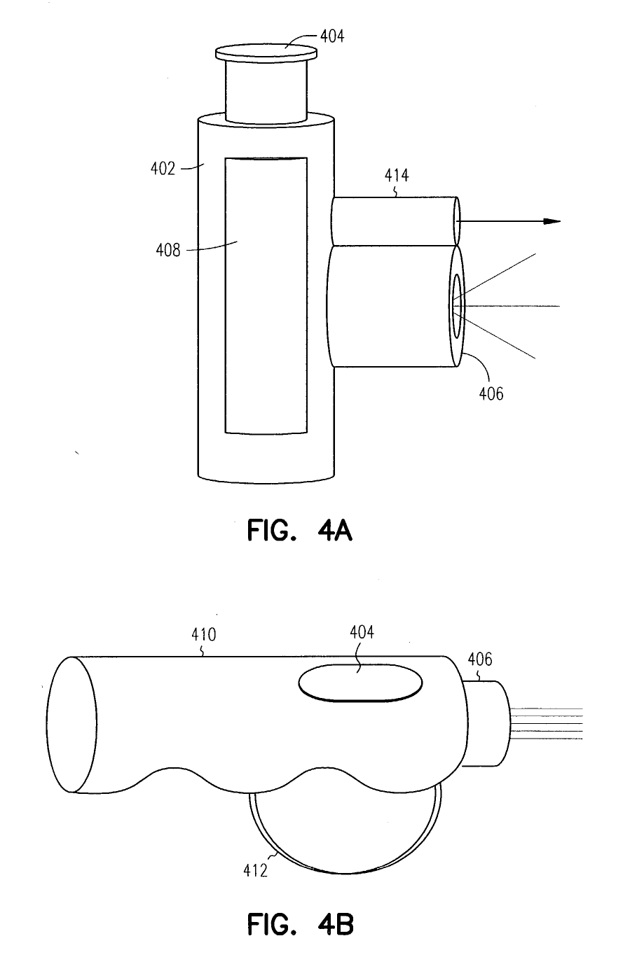

FIG. 4A is an illustration of a wireless supplemental mouse 402 according to an embodiment of the invention. Wireless supplemental mouse 402 includes a battery 408 for powering the internal mouse components. In addition, wireless supplemental mouse 402 includes button 404. Button 404 may be a single button, or it may comprise a “split” button this includes two halves. Each button halve may be independently actuated and is treated as a unique button.

Wireless supplemental mouse 402 also includes a wireless transmitter 406 for emitting a wireless signal suitable for reception by wireless supplemental mouse interface 108. In some embodiments, wireless transmitter 406 emits an infrared signal. In alternative embodiments, wireless transmitter 406 emits a radio-frequency signal. In some embodiments, the signal may correspond to the Bluetooth protocol.

As described with respect to FIG. 1A above, in some embodiments of the invention wireless mouse 402 includes a laser pointing device 414.

FIG. 4B illustrates a wireless supplemental mouse 410 according to an alternative embodiment of the invention. Like mouse 402, mouse 420 may include a wireless transmitter 406 and a mouse button 404, which may be a split mouse button. In addition, mouse 410 includes a finger loop 412 to make it convenient for a user to carry the mouse in the hand while reducing the possibility of misplacing the mouse.

Each of mice 402 and 410 may also include mechanisms to determine movement of the mouse. In some embodiments, such mechanisms include accelerometers to detect movement of the mouse. The mechanisms may then include motion data in the signal transmitted by the mouse.

### Conclusion

Systems and methods for providing a wireless supplemental mouse for interaction with a computer system have been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

What is claimed is:

1. A computerized system comprising:
a computer including a processor, a memory, and a bus coupling the processor and the memory;
a primary mouse coupled to the computer; and
a wireless supplemental mouse interface coupled to the computer.

2. The computerized system of claim 1, wherein the wireless supplemental mouse interface is coupled to the computer through the bus.

3. The computerized system of claim 1, wherein the computer further includes a network interface and wherein the wireless supplemental mouse interface is coupled to the computer through the network interface.

4. The computerized system of claim 1, wherein the wireless supplemental mouse interface includes an infrared interface.

5. The computerized system of claim 1, wherein the wireless supplemental mouse interface includes a radio frequency interface.

6. The computerized system of claim 5, wherein the wireless supplemental mouse interface includes a bluetooth interface.

7. The computerized system of claim 1, wherein the wireless supplemental mouse interface is operable to:
detect proximity of a wireless supplemental mouse;
detect motion of the wireless supplemental mouse; and
display a cursor having a position that changes relative to the motion of the wireless supplemental mouse.

8. The computerized system of claim 7, wherein the cursor is a secondary cursor.

9. The computerized system of claim 1, further comprising at least one wireless supplemental mouse communicably coupled to the wireless supplemental mouse interface.

10. The computerized system of claim 1, wherein the wireless supplemental mouse includes a laser pointing device.

11. A method for interacting with a hand-held mouse, the method comprising:
receiving a signal from a wireless supplemental mouse;
determining from the signal that the wireless supplemental mouse is proximate to a computer;
determining from the signal motion of the wireless supplemental mouse; and
displaying a cursor associated with the wireless supplemental mouse, wherein the cursor moves in relation to the motion of the wireless supplemental mouse.

12. The method of claim 11, wherein receiving a signal receives an infrared signal.

13. The method of claim 11, wherein receiving a signal receives a radio frequency signal.

14. The method of claim 13, wherein the signal corresponds to the Bluetooth protocol.

15. The method of claim 11, wherein the cursor is a secondary cursor.

16. The method of claim 11, further comprising displaying a laser pointer.

17. A method for interacting with a hand-held mouse, the method comprising:
receiving a signal from a wireless supplemental mouse;
determining a selected computer system from a plurality of computer systems to process the signal;
detecting motion of the wireless supplemental mouse; and
displaying a cursor on the selected computer system, wherein the cursor moves in relation to the motion of the wireless supplemental mouse.

18. The method of claim 17, wherein receiving a signal receives an infrared signal.

19. The method of claim 17, wherein receiving a signal receives a radio frequency signal.

20. The method of claim 19, wherein the signal corresponds to the Bluetooth protocol.

21. The method of claim 17, wherein the cursor is a secondary cursor.

22. A computer-readable medium having computer executable instructions for performing a method for interacting with a hand-held mouse, the method comprising:
receiving a signal from a wireless supplemental mouse;
determining from the signal that the wireless supplemental mouse is proximate to a computer;
determining from the signal motion of the wireless supplemental mouse; and
displaying a cursor associated with the wireless supplemental mouse, wherein the cursor moves in relation to the motion of the wireless supplemental mouse.

23. The computer-readable medium of claim 22, wherein receiving a signal receives an infrared signal.

24. The computer-readable medium of claim 22, wherein receiving a signal receives a radio frequency signal.

25. The computer-readable medium of claim 24, wherein the signal corresponds to the Bluetooth protocol.

26. The computer-readable medium of claim 22, wherein the cursor is a secondary cursor.

27. A computer-readable medium having computer-executable instructions for performing a method for interacting with a hand-held mouse, the method comprising:
receiving a signal from a wireless supplemental mouse;
determining a selected computer system from a plurality of computer systems to process the signal;
detecting motion of the wireless supplemental mouse; and
displaying a cursor on the selected computer system, wherein the cursor moves in relation to the motion of the wireless supplemental mouse.

28. The computer-readable medium of claim 27, wherein receiving a signal receives an infrared signal.

29. The computer-readable medium of claim 27, wherein receiving a signal receives a radio frequency signal.

30. The computer-readable medium of claim 29, wherein the signal corresponds to the Bluetooth protocol.

31. The computer-readable medium of claim 27, wherein the cursor is a secondary cursor.
